(19) United States
(12) Patent Application Publication
(10) Pub. No.: US 2017/0245263 A1
(43) Pub. Date: Aug. 24, 2017

(54) PUCCH Resource Allocation and Peak to Average Power Ratio Reduction in eLAA

(71) Applicant: MEDIATEK INC., Hsinchu (TW)

(72) Inventors: Chien-Chang Li, Penghu County (TW); Weidong Yang, San Diego, CA (US); Bo-Si Chen, Keelung City (TW)

(21) Appl. No.: 15/474,299

(22) Filed: Mar. 30, 2017

Related U.S. Application Data
(63) Continuation-in-part of application No. 15/423,999, filed on Feb. 3, 2017.
(60) Provisional application No. 62/291,585, filed on Feb. 5, 2016.
(60) Provisional application No. 62/296,148, filed on Feb. 17, 2016.
(60) Provisional application No. 62/316,611, filed on Apr. 1, 2016.

(51) Int. Cl. H04W 72/04; H04L 5/00; H04L 27/26; H04L 12/24

(52) U.S. Cl. CPC H04W 72/0413; H04W 72/042; H04L 41/0896; H04L 5/0048; H04L 27/262

(57) ABSTRACT

A method of physical uplink control channel (PUCCH) resource allocation to increase multiplexing capacity in enhanced licensed assisted access (eLAA) is proposed. New design of Physical Uplink Control Channel (PUCCH) is proposed. Across frequency domain of the channel bandwidth, multiple resource block repetitions are allocated for different UEs for uplink PUCCH transmission to satisfy the occupied channel bandwidth requirement for unlicensed carrier access. In addition, the resource elements of a single PUCCH resource block are partially spread into different repetitions to increase multiplexing capacity and to resource peak to average power ratio (PAPR).

### CROSS REFERENCE TO RELATED APPLICATIONS

This application is a continuation-in-part of, and claims priority under 35 U.S.C. §120 from nonprovisional U.S. patent application Ser. No. 15/423,999, entitled “PEAK TO AVERAGE POWER RATIO REDUCTION IN ELAA,” filed on Feb. 3, 2017, the subject matter of which is incorporated herein by reference. Application Ser. No. 15/423,999, in turn, claims priority under 35 U.S.C. §119 from U.S. Provisional Application No. 62/291,585, entitled “The Method of PAPR Reduction in eLAA,” filed on Feb. 5, 2016; U.S. Provisional Application No. 62/296,148, entitled “The Method of PAPR Reduction in eLAA,” filed on Feb. 17, 2016, the subject matter of which is incorporated herein by reference. This application also claims priority under 35 U.S.C. §119 from U.S. Provisional Application No. 62/316,611, entitled “Resource Allocation of PUCCH in unlicensed carrier,” filed on Apr. 1, 2016, the subject matter of which is incorporated herein by reference.

### TECHNICAL FIELD

The disclosed embodiments relate generally to wireless network communications, and, more particularly, to peak to physical uplink control channel (PUCCH) resource allocation and average power ratio (PAPR) reduction in licensed assisted access (LAA) wireless communications systems.

### BACKGROUND

Third generation partnership project (3GPP) and Long Term Evolution (LTE) mobile telecommunication systems provide high data rate, lower latency and improved system performances. With the rapid development of “Internet of Things” (IOT) and other new user equipment (UE), the demand for supporting machine communications increases exponentially. To meet the demand of this exponential increase in communications, additional spectrum (i.e. radio frequency spectrum) is needed. The amount of licensed spectrum is limited. Therefore, communications providers need to look to unlicensed spectrum to meet the exponential increase in communication demand. One suggested solution is to use a combination of licensed spectrum and unlicensed spectrum. This solution is referred to as “Licensed Assisted Access” or “LAA”. In such a solution, an established communication protocol such as Long Term Evolution (LTE) can be used over the licensed spectrum to provide a fist communication link, and LTE can also be used over the unlicensed spectrum to provide a second communication link.

Furthermore, while LAA only utilizes the unlicensed spectrum to boost downlink through a process of carrier aggregation, enhanced LAA (eLAA) allows uplink streams to take advantage of the 5 GHz unlicensed band as well. Although eLAA is straightforward in theory, practical usage of eLAA while complying with various government regulations regarding the usage of unlicensed spectrum is not so straightforward. Moreover, maintaining reliable communication over a secondary unlicensed link requires improved techniques.

In 3GPP Long-Term Evolution (LTE) networks, an evolved universal terrestrial radio access network (E-UTRAN) includes a plurality of base stations, e.g., evolved Node-Bs (eNBs) communicating with a plurality of mobile stations referred as user equipment (UEs). Orthogonal Frequency Division Multiple Access (OFDMA) has been selected for LTE downlink (DL) radio access scheme due to its robustness to multipath fading, higher spectral efficiency, and bandwidth scalability. Multiple access in the downlink is achieved by assigning different sub-bands (i.e., groups of subcarriers, denoted as resource blocks (RBs)) of the system bandwidth to individual users based on their existing channel condition. In LTE networks, Physical Downlink Control Channel (PDCCH) is used for downlink scheduling. Physical Downlink Shared Channel (PDSCH) is used for downlink data. Similarly, Physical Uplink Control Channel (PUCCH) is used for carrying uplink control information. Physical Uplink Shared Channel (PUSCH) is used for uplink data.

In some countries, there are requirements on the occupied channel bandwidth for unlicensed carrier access. Specifically, the occupied channel bandwidth shall be between 80% and 100% of the declared nominal channel bandwidth. During an established communication, a device is allowed to operate temporarily in a mode where its occupied channel bandwidth may be reduced to as low as 40% of is nominal channel bandwidth with a minimum of 4 MHz. The occupied bandwidth is defined as the bandwidth containing 99% of the power of the signal. The nominal channel bandwidth is the widest band of frequencies inclusive of guard bands assigned to a single carrier (at least 5 MHz).

A design of PUSCH/PUCCH to satisfy the requirements on the occupied channel bandwidth in eLAA wireless communications network is sought.

### SUMMARY

A method of uplink transmission to reduce peak-to-average power ratio (PAPR) in enhanced licensed assisted access (eLAA) is proposed. New design of Physical Uplink Control Channel (PUCCH) and Physical Uplink Shared Channel (PUSCH) is proposed. Across frequency domain of the channel bandwidth, multiple resource interlaces are allocated for different UEs for uplink PUCCH/PUSCH transmission to satisfy the occupied channel bandwidth requirement for unlicensed carrier access. In addition, uplink transmission with co-phasing terms are applied to reduce PAPR of the resulted waveform.

In one embodiment, a user equipment (UE) obtains a set of resource blocks for an uplink channel in an orthogonal frequency division multiplexing (OFDM) wireless communications network. The set of resource blocks is distributed along frequency domain to occupy a predefined percentage of an entire channel bandwidth. The UE applies a co-phasing vector comprising a set of co-phasing terms, wherein each co-phasing term of the co-phasing vector is applied to a corresponding resource block of the set of resource blocks. The UE transmits a radio signal containing uplink information over the uplink channel applied with the co-phasing vector.

In another embodiment, a base station allocates a first set of resource blocks to a first user equipment (UE) in an orthogonal frequency division multiplexing (OFDM) wireless communications network. The base station allocates a second set of resource blocks to a second UE. The first and the second sets of resource blocks comprise interleaved PRBs forming interlaces along frequency domain. Each interlace occupies a predefined percentage of an entire channel bandwidth. The base station simultaneously schedules the first UE and the second UE for uplink transmission over the first set of resource blocks and the second set of resource blocks respectively.

In another novel aspect, a method of physical uplink control channel (PUCCH) resource allocation to increase multiplexing capacity in enhanced licensed assisted access (eLAA) is proposed. New design of Physical Uplink Control Channel (PUCCH) is proposed. Across frequency domain of the channel bandwidth, multiple resource block repetitions are allocated for different UEs for uplink PUCCH transmission to satisfy the occupied channel bandwidth requirement for unlicensed carrier access. In addition, the resource elements of a single PUCCH resource block are partially spread into different repetitions to increase multiplexing capacity and to resource peak to average power ratio (PAPR).

Other embodiments and advantages are described in the detailed description below. This summary does not purport to define the invention. The invention is defined by the claims.

### BRIEF DESCRIPTION OF THE DRAWINGS

FIG. 1 illustrates a wireless communications system with modified PUCCH/PUSCH and PAPR reduction in accordance with a novel aspect.

FIG. 2 is a simplified block diagram of a wireless transmitting device and a receiving device in accordance with a novel aspect.

FIG. 3 illustrates one example of PUCCH design to satisfy the occupied channel bandwidth requirements.

FIG. 4 illustrates one example of PUCCH design with PUCCH format 4 to satisfy the occupied channel bandwidth requirements.

FIG. 5 illustrates another example of PUCCH design with PUCCH format 4 to satisfy the occupied channel bandwidth requirements.

FIG. 6 illustrates one example of interlaced PUSCH design to satisfy the occupied channel bandwidth requirements.

FIG. 7 illustrates one embodiment of uplink scheduling handling the block issue.

FIG. 8 illustrates one embodiment of uplink scheduling with SRS transmission.

FIG. 9 illustrates one embodiment of applying co-phasing vector for uplink transmission over PUCCH or PUSCH for PAPR reduction.

FIG. 10 illustrates one example of co-phasing vector using DBMS coefficients.

FIG. 11 is flow chart of a method of uplink transmission over PUCCH/PUSCH with PAPR reduction in accordance with one novel aspect.

FIG. 12 is a flow chart of a method of uplink scheduling for PUCCH/PUSCH from base station perspective in accordance with one novel aspect.

FIG. 13 shows the multiplexing capacity of PUCCH formats 1/1a/1b/2/2a/2b/3/4/5.

FIG. 14 illustrates one example of PUCCH spreading with partial REs of one RB in accordance with one novel aspect of the present invention.

FIG. 15 illustrates one example of PUCCH block spreading with partial REs of multiple RBs in accordance with one novel aspect.

FIG. 16 illustrates one example of PUCCH distributed spreading with partial REs of multiple RBs in accordance with one novel aspect.

FIG. 17 is a flow chart of a method of PUCCH resource allocation with partial RE spreading from UE perspective in accordance with one novel aspect.

FIG. 18 is a flow chart of a method of PUCCH resource allocation with partial RE spreading from eNB perspective in accordance with one novel aspect.

### DETAILED DESCRIPTION

Reference will now be made in detail to some embodiments of the invention, examples of which are illustrated in the accompanying drawings.

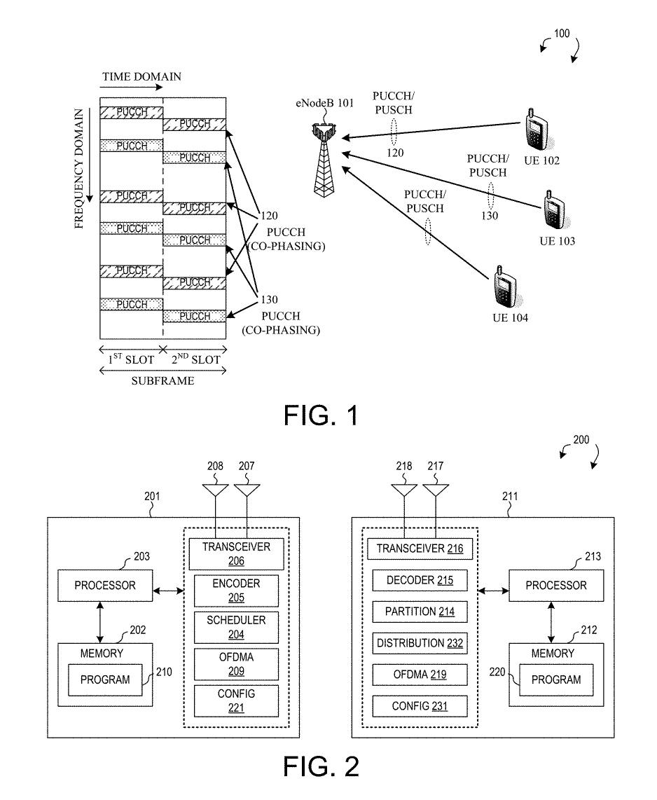

FIG. 1 illustrates a wireless communications system with PUCCH/PUSCH design and PAPR reduction in accordance with a novel aspect. Mobile communication network 100 is an OFDM/OFDMA system comprising a base station eNodeB 101 and a plurality of user equipment UE 102, UE 103, and UE 104. In 3GPP LTE system based on OFDMA downlink, the radio resource is partitioned into subframes in time domain, each subframe is comprised of two slots. Each OFDMA symbol further consists of a number of OFDMA subcarriers in frequency domain depending on the system bandwidth. The basic unit of the resource grid is called Resource Element (RE), which spans an OFDMA subcarrier over one OFDMA symbol. REs are grouped into physical resource blocks (PRBs), where each PRB consists of 12 consecutive subcarriers in one slot.

When there is a downlink packet to be sent from eNodeB to UE, each UE gets a downlink assignment, e.g., a set of radio resources in a physical downlink shared channel (PDSCH). When a UE needs to send a packet to eNodeB in the uplink, the UE gets a grant from the eNodeB that assigns a physical uplink shared channel (PUSCH) consisting of a set of uplink radio resources. The UE gets the downlink or uplink scheduling information from a physical downlink control channel (PDCCH) that is targeted specifically to that UE. In addition, broadcast control information is also sent in PDCCH to all UEs in a cell. The downlink or uplink scheduling information and the broadcast control information, carried by PDCCH, is referred to as downlink control information (DCI). The uplink control information (UCI) including HARQ ACK/NACK, CQI, MIMO feedback, scheduling requests is carried by a physical uplink control channel (PUCCH) or PUSCH if the UE has data or RRC signaling.

Licensed Assisted Access (LAA) has been proposed to meet the exponential increase in communication demand. In LAA, a combination of licensed spectrum and unlicensed spectrum is used. An established communication protocol such as Long Term Evolution (LTE) can be used over the licensed spectrum to provide a fist communication link, and LTE can also be used over the unlicensed spectrum to provide a second communication link. Furthermore, while LAA only utilizes the unlicensed spectrum to boost downlink through a process of carrier aggregation, enhanced LAA (eLAA) allows uplink streams to take advantage of the 5 GHz unlicensed band as well. For unlicensed carrier access, however, there are requirements on the occupied channel bandwidth in some countries. Specifically, the occupied channel bandwidth shall be between 80% and 100% of the declared nominal channel bandwidth. As a result, the legacy PUCCH and PUSCH designs in LTE may not meet such requirements.

In the example of FIG. 1, PUCCH 120 is allocated for UE 102 for uplink control information. The radio resources for PUCCH 120 need to be spread across the frequency domain to satisfy the requirements on the occupied channel bandwidth. PUCCH 130 is allocated for UE 103 for uplink control information. The radio resources for PUCCH 130 also need to be spread across the frequency domain to satisfy the requirements on the occupied channel bandwidth. PUCCH 120 and PUCCH 130 form different resource interlace across the entire frequency domain. Similarly, for PUSCH, if eNodeB 101 schedules a number of UEs in a subframe, then it may not be able to ensure each UE's transmission meets the occupied bandwidth requirement. The radio resources for PUSCH for each UE thus also need to be spread across the frequency domain. For example, a number of resource interlaces over the nominal channel bandwidth with interleaved PRBs may be allocated as PUSCHs to the number of UEs.

The transmit signals in an OFDM system can have high peak values in the time domain since many subcarrier components are added via an Inverse Fast Fourier Transformation (IFFT) operation. As a result, OFDM system are known to have a high peak-to-average power ratio (PAPR) when compared to single-carrier systems. Furthermore, the requirements on the occupied channel bandwidth in LAA result in even higher PAPR since the legacy PUCCH and PUSCH are replicated in the resource interlace across the entire frequency domain. In accordance with one novel aspect, a co-phasing vector is applied to the replicates on different PRBs to reduce the PAPR.

FIG. 2 is a simplified block diagram of wireless devices 201 and 211 in accordance with a novel aspect. For wireless device 201 (e.g., a transmitting device), antennae 207 and 208 transmit and receive radio signal. RF transceiver module 206, coupled with the antennae, receives RF signals from the antennae, converts them to baseband signals and sends them to processor 203. RF transceiver 206 also converts received baseband signals from the processor, converts them to RF signals, and sends out to antennae 207 and 208. Processor 203 processes the received baseband signals and invokes different functional modules and circuits to perform features in wireless device 201. Memory 202 stores program instructions and data 210 to control the operations of device 201.

Similarly, for wireless device 211 (e.g., a receiving device), antennae 217 and 218 transmit and receive RF signals. RF transceiver module 216, coupled with the antennae, receives RF signals from the antennae, converts them to baseband signals and sends them to processor 213. The RF transceiver 216 also converts received baseband signals from the processor, converts them to RF signals, and sends out to antennae 217 and 218. Processor 213 processes the received baseband signals and invokes different functional modules and circuits to perform features in wireless device 211. Memory 212 stores program instructions and data 220 to control the operations of the wireless device 211.

The wireless devices 201 and 211 also include several functional modules and circuits that can be implemented and configured to perform embodiments of the present invention. In the example of FIG. 2, wireless device 201 is a transmitting device that includes an encoder 205, a scheduler 204, an OFDMA module 209, and a configuration circuit 221. Wireless device 211 is a receiving device that includes a decoder 215, a feedback circuit 214, a OFDMA module 219, and a configuration circuit 231. Note that a wireless device may be both a transmitting device and a receiving device. The different functional modules and circuits can be implemented and configured by software, firmware, hardware, and any combination thereof. The function modules and circuits, when executed by the processors 203 and 213 (e.g., via executing program codes 210 and 220), allow transmitting device 201 and receiving device 211 to perform embodiments of the present invention.

In one example, the transmitting device (a base station) configures radio resource (PUCCH/PUSCH) for UEs via configuration circuit 221, schedules downlink and uplink transmission for UEs via scheduler 204, encodes data packets to be transmitted via encoder 205 and transmits OFDM radio signals via OFDM module 209. The receiving device (a user equipment) obtains allocated radio resources for PUCCH/PUSCH via configuration circuit 231, partitions the allocated resource via partitioning circuit 232, distributes different partitions over the allocated resources via resource distribution circuit 232, receives and decodes downlink data packets via decoder 215, and transmits uplink information over the PUCCH/PUSCH applied with co-phasing vector to reduce PAPR of the radio signal via OFDM module 219.

For PUCCH format 1/1a/1a, 2/2a/2b, 3, and 5, the occupied resource in frequency domain is only one PRB and thus the requirement on the occupied channel bandwidth is not satisfied. For PUCCH format 4, there can be more than one resource blocks per PUCCH. PUCCH format 4 contains M_{RB}^{PUCCH4} consecutive PRBs in frequency domain, wherein M_{RB}^{PUCCH4}=1, 2, 3, 4, 5, 6, 8. Since the resource blocks of PUCCH format 4 are contiguous and thus the requirements on the occupied channel bandwidth may not be satisfied as well. For convenience, the resource allocation for PUCCH format 4 is shown below, where nₛ is slot index. There is a shift between slot 0 and slot 1.

$$\begin{matrix}{n}_{PRB} = \{ \begin{matrix}m & if {n}_{s} mod 2 = 0 \\ {N}_{RB}^{UL} - 1 - m & if {n}_{s} mod 2 = 1\end{matrix} \\ m = {n}_{PUCCH}^{( 4 )} , {n}_{PUCCH}^{( 4 )} + 1 , … , {n}_{PUCCH}^{( 4 )} + {M}_{RB}^{PUCCH 4} - 1\end{matrix}$$

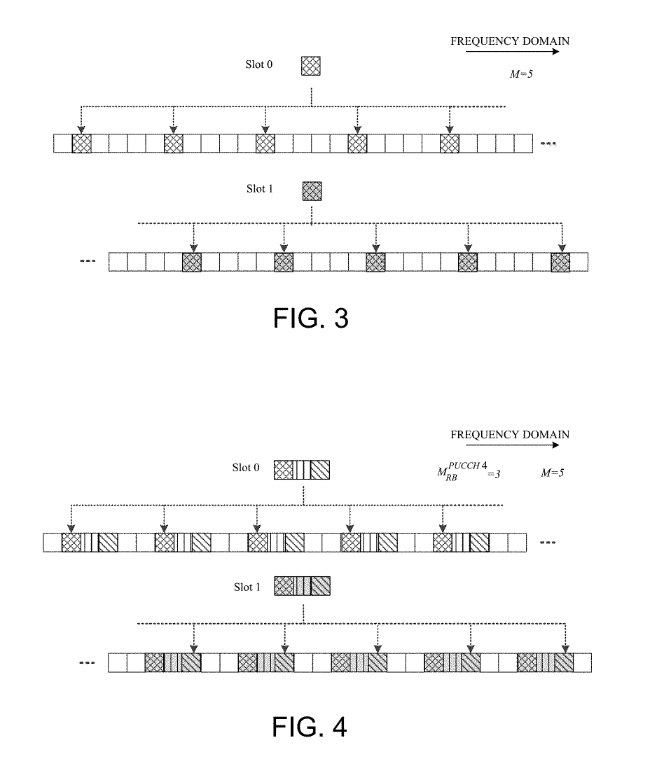

FIG. 3 illustrates one example of PUCCH design to satisfy the occupied channel bandwidth requirements. For PUCCH format 1/1a/1a, 2/2a/2b, 3, and 5, spreading the PUCCH resource in the frequency domain can be considered to satisfy the requirements on the occupied channel bandwidth. For example, the PUCCH resources can be repeated every M RBs. As shown in FIG. 3, M=5 and the index of occupied PUCCH PRBs is {1, 56, 11, . . . , 96}.

FIG. 4 illustrates one example of PUCCH design with PUCCH format 4 to satisfy the occupied channel bandwidth requirements. For PUCCH format 4, two alternatives can be considered to satisfy the requirements on the occupied channel bandwidth. In the example of FIG. 4, the PUCCH resources can be block-spread in frequency domain. For example, the PUCCH resources are repeated every M RBs. As shown in FIG. 4, M_{RB}^{PUCCH4}=3 and M=5. The three consecutive PRBs of PUCCH format 4 are spread in frequency domain by being replicated every five PRBs. The index of occupied PRBs is {1, 2, 3, 6, 7, 8, 11, 12, 13, . . . , 96, 97, 98}.

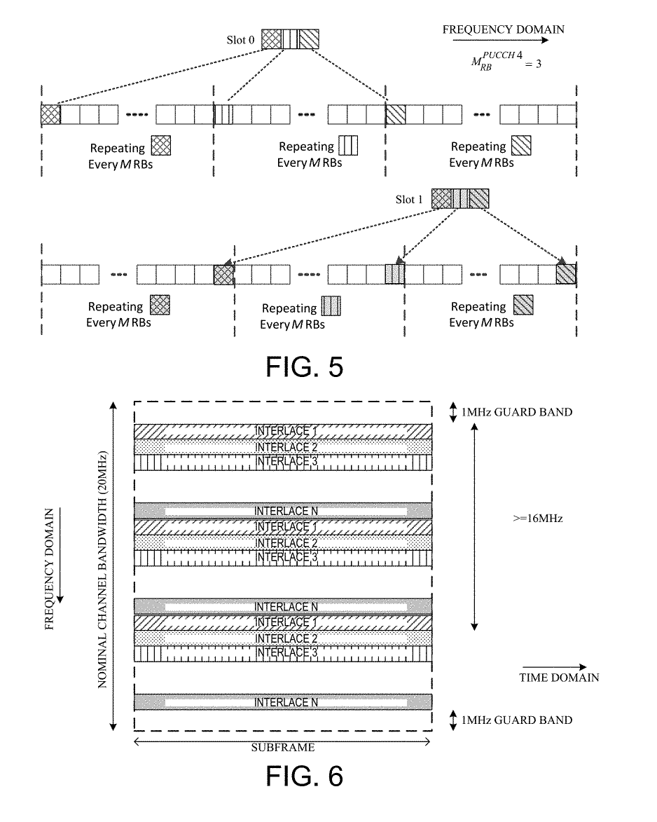

FIG. 5 illustrates another example of PUCCH design with PUCCH format 4 to satisfy the occupied channel bandwidth requirements. In FIG. 5, the resource of PUCCH is first uniformly allocated in the whole bandwidth. Then each PUCCH PRB is spread in the corresponding sub-block or region. For example, in FIG. 5, the three consecutive PRBs of PUCCH format 4 are spread in frequency domain by two steps. In a first step, the three PRBs are spread uniformly in frequency domain, which divides the frequency domain into three regions. In a second step, in each region, each PUCCH PRB is repeated every M RBs in the corresponding sub-block/region. The 1^{st} PUCCH RB is repeated every M RBs in region [0, 32], 2^{nd} PUCCH RB is repeated very M RBs in region [33, 65], and 3^{rd} PUCCH RB is repeated every M RBs in region [66, 99].

In LTE, frequency hopping such as the mirror mapping in intra-subframe frequency hopping can be used to meet the occupied channel bandwidth requirements for a few UEs. From Rel-10, two cluster allocation is also available. Two cluster allocation can be also used to meet the occupied channel bandwidth requirements for a few UEs. However, if eNB needs to schedule a number of UEs in a subframe, then it may not be able to ensure each UE's transmission meets the occupied bandwidth requirements. One possibility is that only a limited number of UEs can be scheduled in a subframe in a region where there are occupied channel bandwidth requirements, and it is up to eNB scheduling to ensure the requirements are met.

FIG. 6 illustrates one example of interlaced PUSCH design to satisfy the occupied channel bandwidth requirements. Using a 20 MHz channel as an example, from the requirement that at 80% occupied bandwidth is required, the frequency interval between the first PRB and the last PRB in an interlace is at least 16 MHz. As depicted in FIG. 6, each resource interlace has the same number of resource units, each resource unit is shown as rectangular block and resource units for one resource interlace are in the same shade. The bandwidth of (N−1) resource units<=2 MHz. One resource interlace is the minimum a UE can be granted with. Hence N is also the number of UEs which can be simultaneously scheduled in one subframe. Assume a resource unit is one PRB, then 2 MHz/180 KHz=11, further N needs to be a factor of 100, the number of PRBs in a subframe, N can be chosen as 10. Assume one or more resource interlaces can be granted to UE, and consider the FFT size for the DFT spreading can have only 2, 3 and 5 as its factors; one UE can be granted with 10, 20, 30, 40, 50, 60, 80, 90 or 100 PRBs in one subframe. Depending on the traffic going through eLAA uplink, the granularity of resource grant may or may not be fine enough. In the event that it is found that a finer granularity becomes necessary, one solution is to use a smaller resource unit, e.g. 6 tones for one resource unit, whereby N=20 can be obtained and one resource interlace consists of 60 tones. Note that along with PUSCH, one or more resource interlace can also be used in PUCCH.

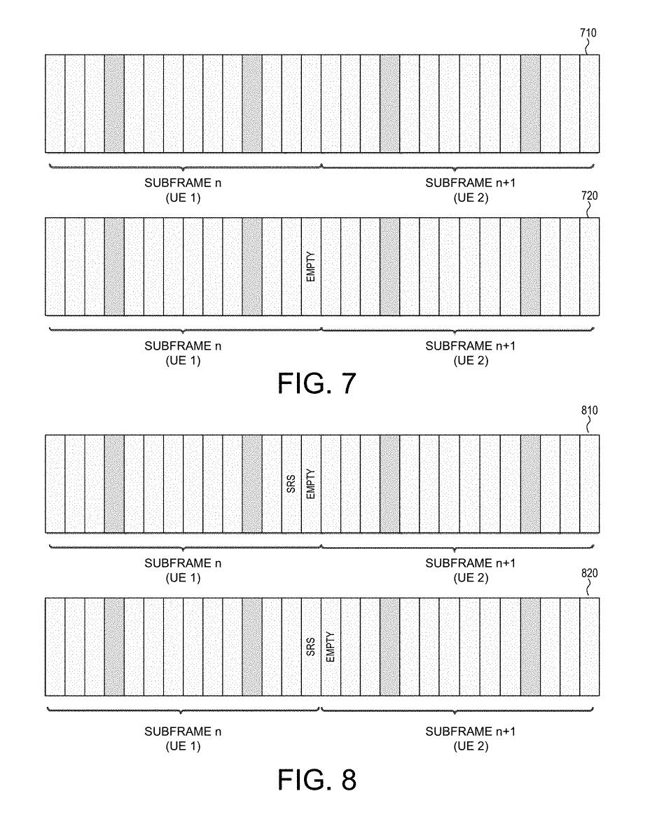

FIG. 7 illustrates one embodiment of uplink scheduling handling the block issue. When eNB schedules two subframes back-to-back to different UEs, the uplink transmission from UE 1 may block the transmission from UE 2 as shown in top diagram 710 of FIG. 7. To avoid that, UE 1 can drop the last symbol in subframe n so to create clear channel assessment (CCA) opportunities for UE 2 scheduled to transmit in subframe n+1 as shown in bottom diagram 720 of FIG. 7.

FIG. 8 illustrates one embodiment of uplink scheduling with sounding reference signal (SRS) transmission. When aperiodic SRS is transmitted along with PUSCH, SRS can still occupy the last symbol in a UE's uplink transmission. When wideband SRS is transmitted, it does not need to use the resource interlace to spread the signal over the whole channel. In another word, spreading over the whole channel through resource interlace is used for PUSCH/PUCCH, but not for SRS. If SRS is requested for UE 1 in subframe n, then a further modification is needed as shown in top diagram 810 of FIG. 8. It is also possible to create the empty symbol at the beginning of subframe n+1 instead of subframe n. The eNB can signal that in the downlink control, e.g. inside a common PDCCH or a PDCCH dedicated to a UE. With the signaling from eNB, a UE scheduled to transmit in subframe n+1 knows the CCA opportunities (empty symbol) are according to top diagram 810 of FIG. 8 (last OFDM symbol in subframe n) or according to bottom diagram 820 of FIG. 8 (first OFDM symbol in subframe n+1).

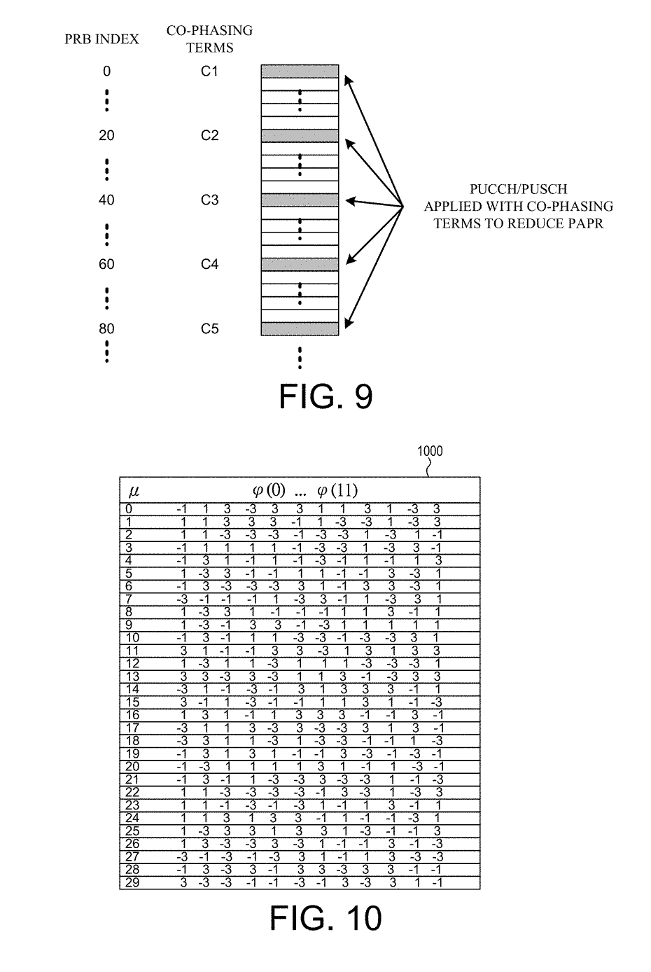

FIG. 9 illustrates one embodiment of applying co-phasing vector for uplink transmission over PUCCH or PUSCH for PAPR reduction. Assume that PUCCH or PUSCH is mapped to one resource interlace, e.g., replicating the legacy PUCCH at all the PRBs in one resource interlace, then the PAPR of the resulted waveform can be very high. For example, assume PUCCH format 2 is replicated over 10 PRBs (e.g., taking one resource interlace (PRBs 1, 11, 21, . . . , 91) out of 100 PRBs in a 20 MHz system), then PAPR can be very high. In accordance with one novel aspect, co-phasing terms are applied to reduce PAPR.

In the example of FIG. 9, suppose the PUCCH occupies one PRB, i.e., the PUCCH signal is r_{k, l}, where 0<=k<=11 is the subcarrier index, and 0<=l<=6 is the OFDM symbol index for slot 0. In slot 0, the PUCCH is repeated in 0^{th}, 20^{th}, 40^{th}, 60^{th}, and 80^{th} PRB. The replicated signals can be represented as:

For 0-th RB, y0_{k,l}=r_{k,l},

For 20-th RB, y1_{k+12*20, l}=r_{k,l},

For 40-th RB, y2_{k+12*40, l}=r_{k,l},

For 60-th RB, y3_{k+12*60, l}=r_{k,l},

For 80-th RB, y4_{k+12*80, l}=r_{k,l},

Since there are 5 repetitions, we need 5 co-phasing terms c0, c1, c2, c3, and c4. Then the resulted signals after co-phasing become:

Z0=y0*C0

Z1=y0*C1

Z2=y0*C2

Z3=y0*C3

Z4=y0*C4

In slot 1, the same procedure is applied. It has been shown that some co-phasing terms applied to the replicates on different PRBs can lead to a lower PAPR in the resulted wave form.

FIG. 10 illustrates one example of co-phasing vector using DBMS coefficients. Specifically, it is found that truncated DMRS coefficients provide good PAPR reduction as compared to the simple replication scheme. For example, in the simple replication scheme, the co-phasing vector is [1, 1, 1, 1, 1, 1, 1, 1, 1, 1] for 10 PRB repetitions, as all the co-phasing terms are equal to one. On the other hand, the base sequence for DMRS coefficients is given by:

r(n)=e^{jφ(n)π/4}
where the value of φ(n) is given by table 1000 in FIG. 10.

For 10 repetitions, in the length-12 DMRS coefficients, elements 1-10, 2-11, or 3-12 are selected as the length-10 co-phasing terms as there are 10 PRBs in a resource interlace. Note there are a total of 30 different sets of DMRS coefficients with different μ values. The different sets of DMRS coefficients can be selected by different cells to be applied to different UEs as the co-phasing terms.

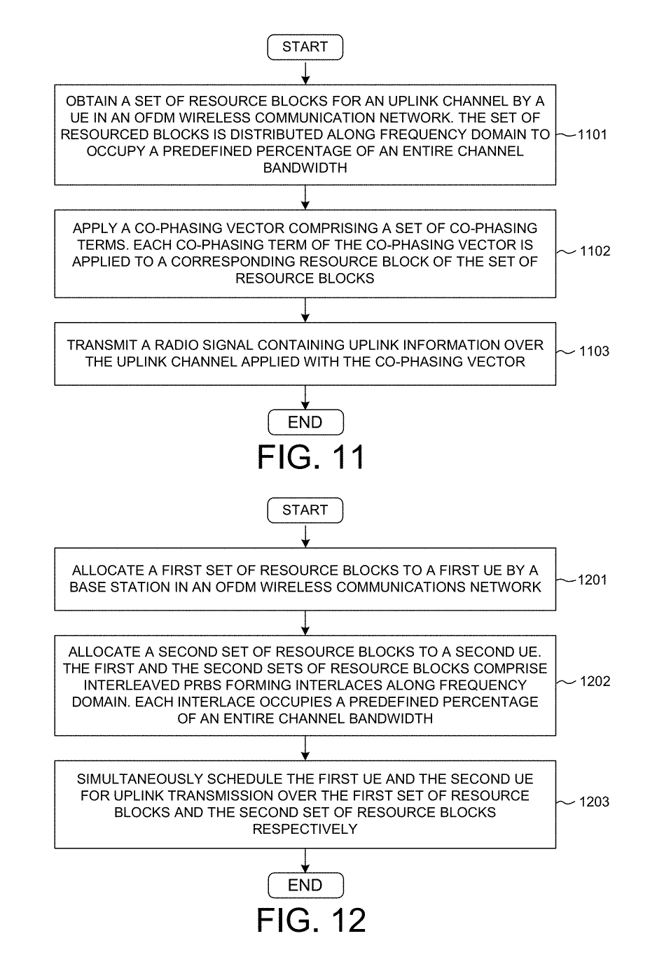

FIG. 11 is flow chart of a method of uplink transmission over PUCCH/PUSCH with PAPR reduction in accordance with one novel aspect. In step 1101, a user equipment (UE) obtains a set of resource blocks for an uplink channel in an orthogonal frequency division multiplexing (OFDM) wireless communications network. The set of resource blocks is distributed along frequency domain to occupy a predefined percentage of an entire channel bandwidth. In step 1102, the UE applies a co-phasing vector comprising a set of co-phasing terms, wherein each co-phasing term of the co-phasing vector is applied to a corresponding resource block of the set of resource blocks. In step 1103, the UE transmits a radio signal containing uplink information over the uplink channel applied with the co-phasing vector.

FIG. 12 is a flow chart of a method of uplink scheduling for PUCCH/PUSCH from base station perspective in accordance with one novel aspect. In step 1201, a base station allocates a first set of resource blocks to a first user equipment (UE) in an orthogonal frequency division multiplexing (OFDM) wireless communications network. In step 1202, the base station allocates a second set of resource blocks to a second UE. The first and the second sets of resource blocks comprise interleaved PRBs forming interlaces along frequency domain. Each interlace occupies a predefined percentage of an entire channel bandwidth. In step 1203, the base station simultaneously schedules the first UE and the second UE for uplink transmission over the first set of resource blocks and the second set of resource blocks respectively.

### Multiplexing Capacity of PUCCH

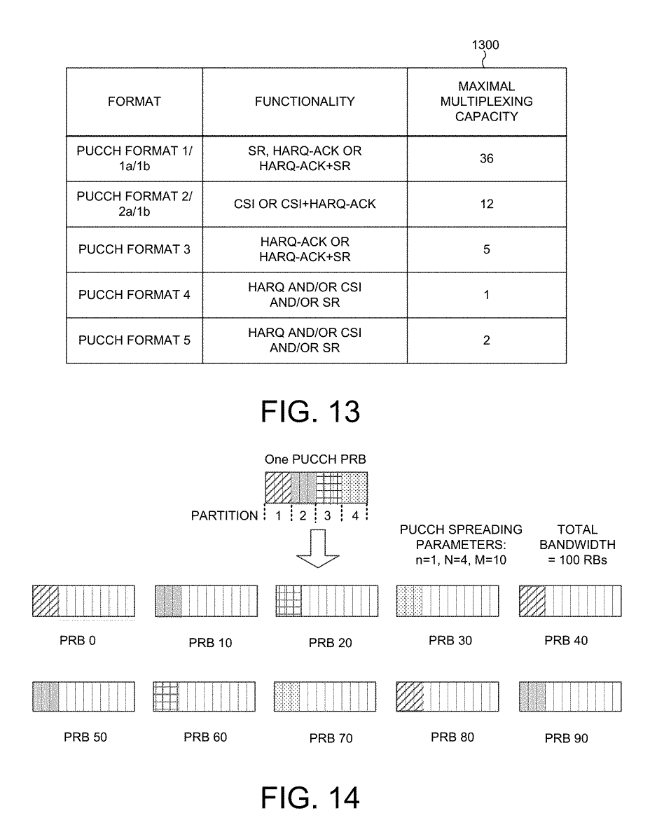

In addition to satisfy the requirement on occupied channel bandwidth, the design of PUCCH should allow multiplexing PUCCH from different UEs as much as possible. FIG. 13 Table 1300 shows the multiplexing capacity of PUCCH formats 1/1a/1b/2/2a/2b/3/4/5. Since PUCCH format 1/1a/1b contains at most 12 cyclic shifts and 3 orthogonal covering codes, the maximal multiplexing capacity is 36. Since PUCCH format 2/2a/2b contains 12 cyclic shifts, the multiplexing capacity is 12. PUCCH format 3 contains 5 orthogonal covering codes, and thus the multiplexing capacity is five. The multiplexing capacity of PUCCH format 4 is only one because it contains neither cyclic shift nor orthogonal covering code. For PUCCH format 5, two orthogonal covering codes are used and thus the multiplexing capacity is two.

Now assume PUCCH format 4 is used and it is repeated every M RBs. There are at most M PUCCHs from different UEs can be multiplexed in a subframe when the size of PUCCH is one RB (n=1). On the other hand, there are at most └M/n┘ PUCCHs from different UEs can be multiplexed in a subframe when the size of PUCCH is n RB. The larger the PUCCH size is, the smaller the capacity is. For example, suppose M=5 and n=1 for all UEs. Then only 5 PUCCHs from different UEs can be multiplexed in a subframe.

To increase the multiplexing capacity, we proposed that the REs of a single PUCCH RB are partially spread into every M RB. One PUCCH RB is partitioned into N equal PUCCH partitions, and each partition contains only 12/N of the 12 REs of the original PUCCH. N is chosen from {1, 2, 3, 4, 6, 12}. In general, the multiplexing capacity of PUCCH format 4 when PUCCH is spread with partial REs is N└M/n┘, which is N times larger than the simple repetition method illustrated earlier in FIGS. 3-5.

FIG. 14 illustrates one example of PUCCH spreading with partial REs of one RB in accordance with one novel aspect. In the example of FIG. 14, each PUCCH occupies one RB (n=1) of 12 REs, which is divided into four PUCCH partitions of three REs (N=4). The different partitions are distributed every 10 RBs (M=10), and each partition is repeated every 40 RBs (N*M=40). For example, the first partition 1 is repeated in RB0, RB40, RB80, the second partition 2 is repeated in RB 10, RB 50, RB90, the third partition 3 is repeated in RB 20, RB 60, and the fourth partition 4 is repeated in RB 30, RB 70. It can been seen that the multiplexing capacity of the proposed partial RE spreading method is N times larger than the simple repetition method. With the simple repetition method, the multiplexing capacity under n=1 and M=10 is (M/n)=10. With the proposed partial RE spreading method, the multiplexing capacity under n=1, N=4, and M=10 is (4(M/n))=40. This is because each PUCCH RB is only occupied with 3 REs, and the remaining unoccupied 9 REs can be used by other UEs for PUCCH transmission.

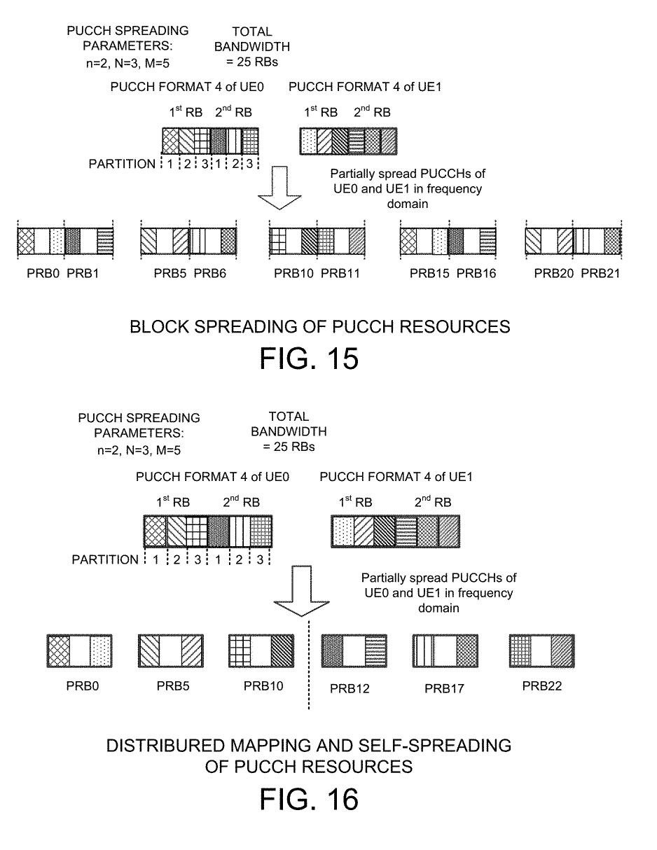

FIG. 15 illustrates one example of partitioned PUCCH block spreading for multiple UEs in accordance with one novel aspect. In the example of FIG. 15, the PUCCH spreading parameters are n=2, N=3, and M=5. The total channel bandwidth is 25 PRBs along frequency domain, identified as PRB0, PRB1, PRB24. This means that the PUCCH format occupies 2 consecutive PRBs (n=2), each PUCCH PRB is divided into 3 equal partitions (N=3), and the partitions are spread along frequency domain every 5 PRBs (M=5). For example, for UE0, the 1^{st} PRB is divided into partition 1, 2, 3, and the 2^{nd} PRB is also divided into partition 1, 2, 3. Partition 1 of the 1^{st} PRB is distributed over PRB0, and partition 1 of the 2^{nd} PRB is distributed over PRB1. Partition 2 of the 1^{st} PRB is distributed over PRB5, and partition 2 of the 2^{nd} PRB is distributed over PRB6. Partition 3 of the 1^{st} PRB is distributed over PRB10, and partition 3 of the 2^{nd} PRB is distributed over PRB11. The same distribution is repeated for PRB15, PRB16, PRB20, and PRB21. Similarly, for UE1, the 1^{st} PRB is divided into partition 1, 2, 3, and the 2^{nd} PRB is also divided into partition 1, 2, 3. Partition 1 of the 1^{st} PRB is distributed over PRB0, and partition 1 of the 2^{nd} PRB is distributed over PRB1. Partition 2 of the 1^{st} PRB is distributed over PRB5, and partition 2 of the 2^{nd} PRB is distributed over PRB6. Partition 3 of the 1^{st} PRB is distributed over PRB10, and partition 3 of the 2^{nd} PRB is distributed over PRB11. The same distribution is repeated for PRB15, PRB16, PRB20, and PRB21. It can be seen that because only partial REs of the PUCCH is spread into each PUCCH PRB, both UE0 and UE1 can share the same PUCCH PRB resource allocation.

To allocated the different PUCCH resource to each UE, the eNB needs to signal the PUCCH PRB and PUCCH partition to each UE. For example, for UE0, the eNB needs to indicate that the PUCCH resource is allocated over PRB0 locates at partition 1, and also PRB1 locates at partition 1. Similarly, for UE1, the eNB needs to indicate that the PUCCH resource is allocated over PRB0 locates at partition 3, and also PRB1 locates at partition 3. If there exists other UEs, then their PUCCH can be allocated in other positions. For example, eNB needs to signal UE2 that its PUCCH resource starts from PRB2 and locates at partition 2, and UE3 its PUCCH resource starts from PRB 0 and locates at partition 2. After each UE receives its own signaling, then it can derive the allocated PUCCH resource and perform uplink transmission.

FIG. 16 illustrates one example of partitioned PUCCH distributed mapping with self-spreading for multiple UEs in accordance with one novel aspect. In the example of FIG. 16, the PUCCH spreading parameters are n=2, N=3, and M=5. The total channel bandwidth is 25 PRBs along frequency domain, identified as PRB0, PRB1, . . . PRB24. This means that the PUCCH format occupies 2 consecutive PRBs (n=2), each PUCCH PRB is divided into 3 equal partitions (N=3), and the partitions are spread along frequency domain every 5 PRBs (M=5). For both UE0 and UE1, the 1^{st} PRB is divided into partition 1, 2, 3, and the 2^{nd} PRB is also divided into partition 1, 2, 3. The entire channel bandwidth is divided into n=2 sections, the partitions for the 1^{st} RB are mapped to the first section PRB0-PRB11, and the partitions for the 2^{nd} RB are mapped to the second section PRB12-PRB24. For example, for the 1^{st} RB, partition 1 for UE0 and UE1 are mapped to PRB0, partition 2 for UE0 and UE1 are mapped to PRB5, and partition 3 for UE0 and UE1 are mapped to PRB10. On the other hand, for the 2^{nd} RB, partition 1 for UE0 and UE1 are mapped to PRB12, partition 2 for UE0 and UE1 are mapped to PRB17, and partition 3 for UE0 and UE1 are mapped to PRB22.

When the PUCCH resource is spread in the frequency domain, PAPR becomes larger than the case without spreading. Under the proposed method of PUCCH repetition with partial RE spreading, it not only increases the multiplexing capacity, but also reduces the PAPR as compared to the simple PUCCH repetition method. Furthermore, the earlier proposed co-phasing vector can also be applied to further reduce the PAPR of the resulted radio signal waveform.

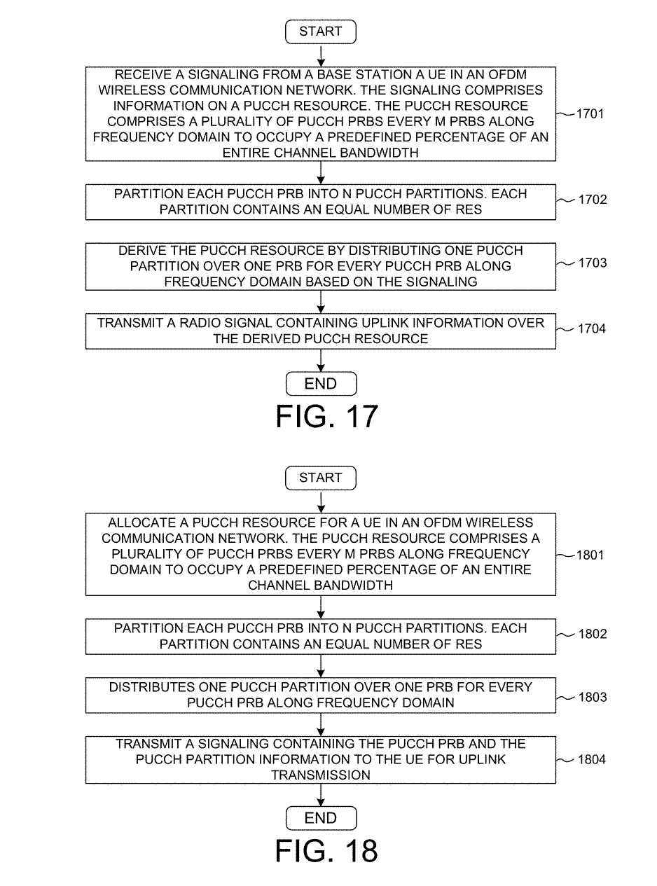

FIG. 17 is a flow chart of a method of PUCCH resource allocation with partial RE spreading from UE perspective in accordance with one novel aspect. In step 1701, a UE receives a signaling from a base station in an orthogonal frequency division multiplexing (OFDM) wireless communications network. The signaling comprises information for a physical uplink control channel (PUCCH) resource. The PUCCH resource comprises a plurality of PUCCH physical resource blocks (PRBs) every M PRBs along frequency domain to occupy a predefined percentage of an entire channel bandwidth. In step 1702, the UE partitions each PUCCH PRB into N PUCCH partitions, each partition contains an equal number of resource elements (REs). In step 1703, the UE derives the PUCCH resource by distributing one PUCCH partition over one PRB for every PUCCH PRB along frequency domain based on the signaling. Finally, in step 1704, the UE transmits a radio signal containing uplink control information over the derived PUCCH resource.

FIG. 18 is a flow chart of a method of PUCCH resource allocation with partial RE spreading from eNB perspective in accordance with one novel aspect. In step 1801, a base station allocates a physical uplink control channel (PUCCH) resource for a user equipment (UE) in an orthogonal frequency division multiplexing (OFDM) wireless communications network. The PUCCH resource comprises a plurality of PUCCH physical resource blocks (PRBs) every M PRBs along frequency domain to occupy a predefined percentage of an entire channel bandwidth. In step 1802, the base station partitions each PUCCH PRB into N PUCCH partitions, each partition contains an equal number of resource elements (REs). In step 1803, the base station distributes each PUCCH partition over one PRB for every PUCCH PRB along frequency domain. In step 1804, the base station transmits a signaling containing the PUCCH PRB and the PUCCH partition information to the UE for uplink transmission.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving a signaling from a base station by a user equipment (UE) in an orthogonal frequency division multiplexing (OFDM) wireless communications network, wherein the signaling comprises information on a physical uplink control channel (PUCCH) resource, and wherein the PUCCH resource comprises a plurality of PUCCH physical resource blocks (PRBs) every M PRBs along frequency domain to occupy a predefined percentage of an entire channel bandwidth;
partitioning each PUCCH PRB into N PUCCH partitions, wherein each partition contains an equal number of resource elements (REs);
deriving the PUCCH resource by distributing one PUCCH partition over one PRB for every PUCCH PRB along frequency domain based on the signaling; and
transmitting a radio signal containing uplink control information over the derived PUCCH resource.

2. The method of claim 1, wherein the PUCCH has a format of occupying one PRB, wherein the N PUCCH partitions are distributed every M PRBs, and wherein each PUCCH partition is repeated every N*M PRBs.

3. The method of claim 1, wherein the PUCCH has format of occupying n consecutive PRBs partitioned into n*N PUCCH partitions, wherein the n*N PUCCH partitions are distributed every M PRBs.

4. The method of claim 3, wherein every n PUCCH partitions correspond to every n consecutive PRBs are distributed over n consecutive PRBs every M PRBs.

5. The method of claim 3, wherein an entire channel bandwidth is partitioned into n sections, and wherein each of the N PUCCH partitions correspond to one of the n consecutive PRBs are distributed over one PRB every M RPBs within one of the n sections.

6. The method of claim 1, wherein a co-phasing vector is applied to the set of resource blocks to reduce a peak to average power ratio (PAPR) of the radio signal.

7. The method of claim 6, wherein the co-phasing vector comprises a number of demodulation reference signal (DMRS) coefficients.

8. A user equipment (UE) comprising:
a receiver that receives a signaling from a base station by a user equipment (UE) in an orthogonal frequency division multiplexing (OFDM) wireless communications network, wherein the physical signaling comprises information on a physical uplink control channel (PUCCH) resource, wherein the PUCCH resource comprises a plurality of PUCCH physical resource blocks (PRBs) every M PRBs along frequency domain to occupy a predefined percentage of an entire channel bandwidth;
a partitioning circuit that partitions each PUCCH PRB into N PUCCH partitions, wherein each partition contains an equal number of resource elements (REs);
a resource allocation circuit that derives the PUCCH resource by distributing one PUCCH partition over one PRB for every PUCCH PRB along frequency domain based on the signaling; and
a transmitter that transmits a radio signal containing uplink control information over the derived PUCCH resource.

9. The UE of claim 8, wherein the PUCCH has a format of occupying one PRB, wherein the N PUCCH partitions are distributed every M PRBs, and wherein each PUCCH partition is repeated every N*M PRBs.

10. The UE of claim 8, wherein the PUCCH has format of occupying n consecutive PRBs partitioned into n*N PUCCH partitions, wherein the n*N PUCCH partitions are distributed every M PRBs.

11. The UE of claim 10, wherein every n PUCCH partitions correspond to every n consecutive PRBs are distributed over n consecutive PRBs every M PRBs.

12. The UE of claim 10, wherein an entire channel bandwidth is partitioned into n sections, and wherein each of the N PUCCH partitions correspond to one of the n consecutive PRBs are distributed over one PRB every M RPBs within one of the n sections.

13. The UE of claim 8, wherein a co-phasing vector is applied to the set of resource blocks to reduce a peak to average power ratio (PAPR) of the radio signal.

14. The UE of claim 13, wherein the co-phasing vector comprises a number of demodulation reference signal (DMRS) coefficients.

15. A method comprising:
allocating a physical uplink control channel (PUCCH) resource for a user equipment (UE) in an orthogonal frequency division multiplexing (OFDM) wireless communications network, wherein the PUCCH resource comprises a plurality of PUCCH physical resource blocks (PRBs) every M PRBs along frequency domain to occupy a predefined percentage of an entire channel bandwidth;
partitioning each PUCCH PRB into N PUCCH partitions, wherein each partition contains an equal number of resource elements (REs);
distributing one PUCCH partition over one PRB for every PUCCH PRB along frequency domain; and
transmitting a signaling containing the PUCCH PRB and the PUCCH partition information to the UE for uplink transmission.

16. The method of claim 15, wherein the PUCCH has a format of occupying one PRB, wherein the N PUCCH partitions are distributed every M PRBs, and wherein each PUCCH partition is repeated every N*M PRBs.

17. The method of claim 15, wherein the PUCCH has format of occupying n consecutive PRBs partitioned into n*N PUCCH partitions, wherein the n*N PUCCH partitions are distributed every M PRBs.

18. The method of claim 17, wherein every n PUCCH partitions correspond to every n consecutive PRBs are distributed over n consecutive PRBs every M PRBs.

19. The method of claim 17, wherein an entire channel bandwidth is partitioned into n sections, and wherein each of the N PUCCH partitions correspond to one of the n consecutive PRBs are distributed over one PRB every M RPBs within one of the n sections.

20. The method of claim 15, wherein a second set of resource blocks is allocated to a second UE, and wherein the first set of resource blocks and the second set of resource blocks occupy overlapping PUCCH PRBs.
